(19) United States
(12) Patent Application Publication
(10) Pub. No.: US 2025/0381837 A1
(43) Pub. Date: Dec. 18, 2025

(54) DRIVE DEVICE FOR A VEHICLE

(71) Applicant: ZF Friedrichshafen AG, Friedrichshafen (DE)

(72) Inventors: Hermann Lanz, Frickingen (DE); Sylva Rother, Kressbronn am Bodensee (DE); Mario Holder, Tettnang (DE); Berthold Schraff, Friedrichshafen (DE); Frank Sauter, Meckenbeuren (DE); Horst Leichsenring, Meinheim (DE)

(73) Assignee: ZF Friedrichshafen AG, Friedrichshafen (DE)

(21) Appl. No.: 19/239,301

(22) Filed: Jun. 16, 2025

(30) Foreign Application Priority Data
Jun. 17, 2024 (DE) 10 2024 205 579.4

(51) Int. Cl. B60K 11/02; B60K 1/02; B60K 17/02; B60K 17/04

(52) U.S. Cl. CPC B60K 11/02; B60K 1/02; B60K 17/02; B60K 17/04

(57) ABSTRACT

A drive unit for a vehicle includes a gearbox having an input element configured to introduce a drive power into the gearbox, and a clutch device with a clutch actuating device. A first drive machine is configured to drive the vehicle and can be mechanically and functionally connected to the input element. A second drive machine is configured to drive the vehicle and can be mechanically and functionally connected to the input element by way of the clutch device. A first housing defines a clutch space for accommodating the clutch actuating device and a drive space for accommodating the first drive machine. Relative to the clutch space, the drive space is arranged in the axial direction offset to a first side. A heat exchanger is arranged radially between an outer circumference of the clutch actuating device and an inner circumference of the first housing inside the clutch space.

### RELATED APPLICATIONS

This application claims the benefit of and right of priority under 35 U.S.C. § 119 to German Patent Application no. DB 10 2024 205 579.4, filed on 17 Jun. 2024, the contents of which are incorporated herein by reference in its entirety

### TECHNICAL FIELD

The present invention relates to a drive unit for a vehicle and to a vehicle with a drive unit.

### BACKGROUND

Drive units for vehicles are known. With the increasing complexity of vehicles and the ever-larger number of components and assemblies built into vehicles, it is advantageous for individual components and the drive unit as a whole to take up little fitting space.

### SUMMARY OF THE INVENTION

A purpose of the present invention is to provide an improved drive unit which takes up little fitting space.

This objective is achieved by a drive unit having the features disclosed herein. Advantageous further developments will be apparent from the present disclosure.

In a first aspect of the invention a drive unit for a vehicle is proposed. The vehicle can be a utility vehicle such as a truck. The vehicle can be a hybrid vehicle. The drive unit comprises a gearbox, a first drive machine, a second drive machine, and a heat exchanger. The gearbox comprises an input element designed to introduce a drive power into the gearbox. The clutch device comprises a clutch actuating device. The first drive machine is designed to drive the vehicle and can be mechanically functionally connected to the input element. The second drive machine is designed to drive the vehicle The second drive machine can be mechanically and functionally connected to the input element by way of the clutch device. The drive unit comprises a first housing which has a clutch space for accommodating the clutch actuating device and a drive space for accommodating the first drive machine. In relation to the clutch space, the drive space is arranged in the axial direction offset to one side. The heat exchanger is arranged inside the clutch space in a radial direction between an outer circumference of the clutch actuating device and an inner circumference of the first housing. It that way a drive unit occupying a compact fitting space is produced.

When two elements are mechanically and functionally connected, they are coupled to one another directly or indirectly in such manner that a movement of one element brings about a reaction of the other element. For example, a mechanical functional connection can be produced by an interlocking or a frictional connection. The mechanical and functional connection can be produced by the meshing of corresponding teeth on the two elements, for example one or more spur gear stage can be provided. In contrast, a permanent rotationally fixed connection of two elements is understood to be a connection in which the two elements are solidly coupled with one another in all normal conditions of the transmission. In such a case the elements can be individual components connected rotationally fixed to one another, or even components made integrally as one piece. On the other hand, by means of a shifting element, for example a clutch or brake, a rotationally fixed connection between two elements can be selectively made or separated.

The gearbox can be in the form of a multi-gear transmission. The input element can be in the form of an input shaft. The input element can be orientated in the axial direction. The input element can define a rotation axis. The radial direction can be directed relative to the axial direction. The input element can be made in more than one part.

The clutch device can be arranged coaxially with the input element. The clutch device can comprise clutch elements such as friction disks. The clutch device can comprise a single-disk or a two-disk clutch. The clutch device can comprise a dual clutch module or a torque converter clutch. The clutch device can be arranged offset in the axial direction, for example on a second side in the axial direction relative to the first drive machine. The clutch actuating device can be in the form of a pneumatic clutch actuating device. The clutch actuating device can comprise a disk spring. Relative to the heat exchanger, the disk spring can be arranged in the axial direction offset toward the second side. The disk spring can cover the heat exchanger in the radial direction.

The first drive machine can be arranged coaxially with the input element. The first drive machine can be in the form of an electric machine, for example, an electric motor or a permanent-magnet electric motor Relative to the clutch device, the first drive machine can be arranged on the first side. The first drive machine can be designed to be cooled by a liquid, for example oil. The second drive machine can comprise an internal combustion engine. The second drive machine can comprise an electric machine.

The drive input device can comprise a transmission gear, for example a reduction gear to reduce a drive input rotation speed of the first drive machine. The transmission gear can be arranged in the radial direction, inside the first drive machine made, for example, as an electric motor. The transmission gear can be arranged in the axial direction in the same plane as the first drive machine. The first drive machine can be mechanically connected to the input element of the gearbox, for example by way of the transmission gear. The transmission gear can be designed to be lubricated by the liquid used to cool the first drive machine.

The heat exchanger can be designed as a plate-type heat exchanger. The heat exchanger can be designed to contain a liquid. By virtue of the heat exchanger, beat can be transferred between two liquid circuits The heat exchanger can be designed to cool a liquid in the drive space. The heat exchanger can be arranged in the axial direction in the same plane as the clutch actuating device. The heat exchanger can extend in the circumferential direction in sections along the clutch actuating device. In the axial direction the heat exchanger can have a rectangular shape

In an embodiment of the drive unit the heat exchanger can be designed to transfer heat from a liquid in the drive space to a liquid of an external cooling circuit. In that way the liquid in the drive space can be cooled effectively. The heat exchanger can have four liquid transfer interfaces. Each of the liquid transfer interfaces can have a cylindrical shape, for example, at least a shape with a projection and a recess. Each of the liquid transfer interfaces can be orientated in the axial direction The liquid transfer interfaces for the liquid from the drive space can be arranged farther inside in the radial direction than the liquid transfer interfaces for the liquid of the external cooling circuit.

In an embodiment of the drive unit the heat exchanger can be in the form of an off-water heat exchanger. The liquid in the drive space can be oil. The liquid in the drive space can be drawn out of the drive space by a liquid pump, for example an oil pump. The liquid in the external cooling circuit can be water or an aqueous mixture. The external cooling circuit is designed to cool the second drive machine.

In an embodiment of the drive unit, the clutch space can be separated from the drive space by an intermediate wall. The intermediate wall can have a number of liquid ducts which are fluidically connected to the heat exchanger. In that way a cooling circuit for the liquid from the drive space, which occupies a compact space, is provided.

The clutch space can be fluidically sealed relative to the drive space, for example sealed in an oil-tight manner. The drive space can form an oil chamber. The clutch space can form an air space. The cutch space can be in the form of a clutch bell. The input element can comprise a transfer element connected rotationally fixed to the input element. The input element can extend in the axial direction through the aforesaid intermediate wall. The intermediate wall can have two liquid ducts, one of which is in fluidic connection with one of the liquid transfer interfaces for the liquid from the drive space. The two liquid duets for the liquid from the drive space can extend in the axial direction through the intermediate wall, for example from the clutch space to the drive space. The intermediate wall can have two liquid ducts, one of which is in fluidic connection with one of the liquid transfer interfaces for the liquid from the external cooling circuit The two liquid ducts for the external cooling circuit can extend outward in the radial direction.

In an embodiment of the drive unit, the heat exchanger can be attached to the intermediate wall. The heat exchanger can be arranged in the axial direction between the intermediate wall and the disk spring of the clutch actuating device. The heat exchanger can be attached to the intermediate wall by means of a number of screw connections, for example four of them. The liquid transfer interfaces of the heat exchanger can end at or open into the intermediate wall.

When two elements are attached to one another, they are coupled to one another directly or indirectly in such manner that a movement of one element brings about essentially the same movement of the other element For example, an attachment can be produced by an interlocking or frictional connection such as a screw connection or a clamp connection. Between the elements there can be provided further elements, for example transfer elements, spacers or the like

In an embodiment of the drive unit, two liquid ducts can open onto an outer circumference of the first housing. In that way, the drive unit can be used flexibly for different external cooling circuits. Bach of the liquid ducts can have at its end a liquid transfer interface on the outer circumference of the first housing, which is designed to let in or let out liquid of the external cooling circuit. The liquid transfer interfaces can have a cylindrical shape, such as a recess. The liquid transfer interfaces for the liquid of the external cooling circuit can be orientated in a plane transverse to the axial direction. The liquid transfer interfaces for the liquid of the external cooling circuit can be arranged in the radial direction. The liquid transfer interfaces for the liquid of the external cooling circuit can be arranged offset in the axial direction relative to the intermediate wall. The liquid transfer interfaces for the liquid of the external cooling circuit can be arranged parallel to one another.

In an embodiment of the drive unit, the first housing can be designed in the form of a cylinder.

In an embodiment of the drive unit, the drive unit can comprise a second housing. inside which the gearbox is arranged. An end section of the second housing on the second side can be made cylindrical. The first housing can be attached to the second housing by way of fixing sections, for example first fixing sections. The fixing sections of the first housing can each be in the form of screwed-on sections. A screwed-on section can comprise at least one of a through-going bore, a threaded bore, and as crew. Each of these screwed-on sections can be orientated in the axial direction. The first fixing sections of the first housing can be arranged uniformly an equal distance apart in the circumferential direction Relative to the rotation axis the first fixing sections can be at an angle of 30° to one another. The first fixing sections of the first housing can be arranged in the radial direction on the same circumference, for example a diameter. The first fixing sections can be arranged radially symmetrically.

The second housing can have fixing sections. The fixing sections of the second housing can each be m the form of screwed-on sections. A screwed-on section can comprise at least one of a threaded bore, a through-going bore and a screw. The fixing sections of the second housing can be positioned so as to coincide with at least some of the first fixing sections of the first housing in the radial direction and the circumferential direction. The fixing sections of the second housing can be in the form of an SAE 1 flange according to DIN ISO 7649

In an embodiment of the drive unit, the drive unit can comprise a third housing, inside which clutch elements of the clutch device are accommodated. The third housing can be cylindrical. The third housing can be attached to the second housing by means of fixing sections. The first housing, the end section of the second housing and the third housing can form a cylindrical shape. This provides a compact drive unit in terms of fitting space. In a simple manner the drive unit can be integrated in a vehicle, for example in a longitudinal direction between chassis elements of a main frame.

The first housing can have second fixing sections spaced uniformly apart from one another on the second side in the circumferential direction. The second fixing sections of the first housing can each be in the form of screwed-on sections. A screwed-on section can comprise at least one of a through-going bore, a threaded bore and a screw. Each of these screwed-on sections can be orientated in the axial direction. The second fixing sections of the first housing can be arranged uniformly apart from one another in the circumferential direction. Relative to the rotation axis the second fixing sections can be at an angle of 30° to one another. The second fixing sections of the first housing can be arranged in the radial direction on the same circumference, for example a diameter. The second fixing sections can be arranged radially symmetrically.

The fixing sections of the third housing can each be in the form of screwed-on sections. A screwed-on section can comprise at least one of a through-going bore, a threaded bore and a screw. The fixing sections of the third housing can be arranged to coincide in the radial and circumferential directions with the first fixing sections of the first housing. In that way the first housing can optionally be attached in a reference orientation, rotated by 30° in one direction, or rotated by 30° in another direction relative to the reference orientation in relation to the third housing. A reference orientation can for example be formed by a vertical orientation of the first housing. The vertical orientation can be related to the direction of gravity for a vehicle which is positioned on level ground with no inclination. In the vertical orientation, for example an electrical connector for supplying the first drive machine with electric power can be arranged above in the direction of gravity. In that way the first housing can be attached to the third housing in three angular positions.

According to a second aspect of the invention, a vehicle comprises a drive unit according to any of the above embodiments and at least one drive element designed to drive the vehicle by means of the drive unit. Further features, effects, and advantages of the second aspect can emerge from the first aspect. Furthermore, features, effects and advantages of the second aspect are also features, effects and advantages pertaining to the first aspect. The vehicle can be a utility vehicle, such as a truck. The vehicle can be a hybrid vehicle. The vehicle can be designed to be driven by at least one of the first and the second drive machines. The drive element can be in the form of a drive gear. The drive element can be in the form of a chain drive. The vehicle can have two drive elements, for example two driven front wheels or rear wheels. The drive unit can be mechanically functionally connected to the drive element by way of cardan shafts. The cardan shafts can provide at least one of a steering angle and a vertical movement in the direction of gravity for the drive element.

### BRIEF DESCRIPTION OF THE FIGURES

FIG. 1 shows a sectioned view of an embodiment of a drive unit for a vehicle

FIG. 2 shows a further sectioned view of the embodiment of the drive unit.

FIG. 3 shows a sectioned perspective view of an embodiment of the drive unit.

FIG. 4 shows a view from above, of an embodiment of the vehicle with the drive unit

FIG. 5 shows a view from above, of a representation of the principle of the vehicle with the drive unit.

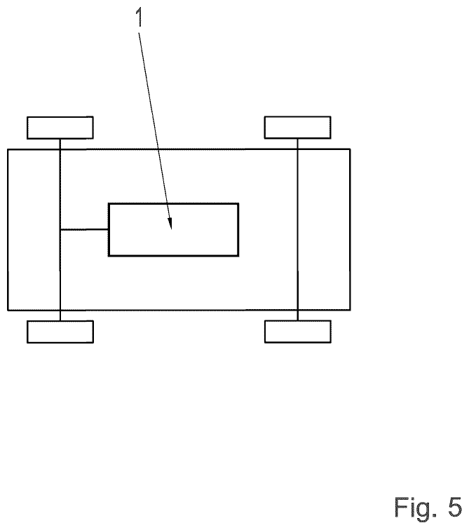

### DETAILED DESCRIPTION OF EMBODIMENTS

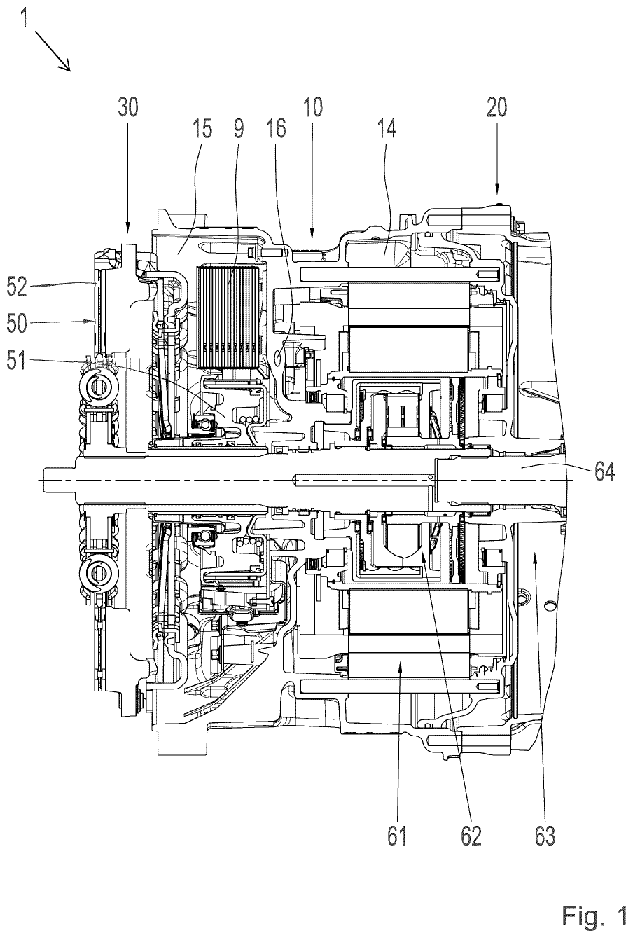

FIG. 1 shows a sectioned view of an embodiment of a drive unit 1 for a vehicle. The vehicle is in the form of a hybrid vehicle. The drive unit 1 comprises a first drive machine 61, a second drive machine, a heat exchanger 9. a first housing 10, a second housing 20, a third housing 30, a clutch device 50, a transmission gear 62, and a gearbox 63. The gearbox has an input element 64. The clutch device 50, the first drive machine 61, and the transmission gear 62 are arranged coaxially with the input element 64. The first drive machine 61 and the transmission gear 62 are arranged in the axial direction between the clutch device 50 and the gearbox 63.

The second drive machine, in the present case an internal combustion engine, is designed to drive the vehicle. A liquid from an external cooling circuit is designed to cool the second drive machine. The second drive machine can be mechanically functionally connected via the clutch device 50 to the input element 64 of the gearbox 63. The input element 64 is designed to introduce drive power into the gearbox 63. The input element 64 is orientated in the axial direction. In this case the input element 64 is made in two parts. The input element 64 extends in the axial direction through the first drive machine 61, the transmission gear 62 and the clutch device 50.

The first drive machine 61, in the present case a permanent-magnet electric motor, is designed to drive the vehicle. The first drive machine 61 as mechanically and functionally connected via the transmission gear 62 to the input element 64. The transmission gear 62 is arranged in the axial direction in the same plane as the first drive machine 61. The transmission gear 62 is arranged in the radial direction inside the first drive machine 61.

The first housing 10 bas a drive space 14 on a first side, namely the right-hand side in FIG. 1, and a clutch space 15 on a second side, the left-hand side in FIG. 1. The church space 15 is designed to accommodate the clutch actuating device 51. The drive space 14 is designed to accommodate the first drive machine 61. The drive space 14 is arranged in the axial direction offset to the first side relative to the clutch space 15. The first housing 10 has an intermediate wall by which the drive space 14 is separated from the clutch space 15. A liquid, in this case oil, is present in the drive space. The liquid in the drive space 14 serves to lubricate the transmission gear 62 and to cool the first drive machine 61.

The heat exchanger 9, in this case an oil-water heat exchanger, is arranged inside the clutch space 15 in the radial direction between an outer circumference of the clutch actuating device 51 and an inner circumference of the first housing 10. The heat exchanger 9 is in the form of a plate-type heat exchanger. The plates of the heat exchanger 9 are stacked in the axial direction. The heat exchanger 9 is designed to convey heat from the liquid in the drive space 14 to a liquid in the external cooling circuit. The heat exchanger is designed to cool the liquid in the drive space 14. The heat exchanger 9 has four liquid transfer interfaces. respectively two for the liquid from the drive space 14 and two for the liquid in the external cooling circuit. Each of the liquid transfer interfaces is orientated in the axial direction. The liquid transfer interfaces for the liquid from the drive space 14 are arranged in the radial direction farther inside than the liquid transfer interfaces for the liquid in the external cooling circuit. The liquid transfer interfaces of the heat exchanger 9 are arranged in the intermediate wall.

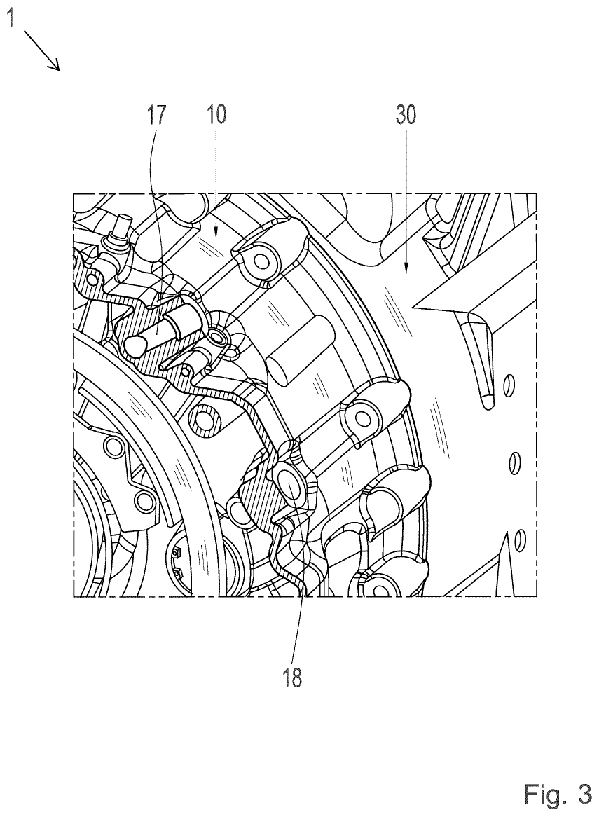

The intermediate wall has a number of liquid ducts, for example a first liquid duct 16. A second liquid duct 17 and a third liquid duct 18 are shown in FIG. 3. The liquid ducts are in fluidic connection with the beat exchanger 9 by way of the liquid transfer interfaces of the heat exchanger 9. Two liquid ducts for the liquid from the drive space 14 extend in the axial direction through the intermediate wall. Two liquid ducts for the external cooling circuit extend outward in the radial direction. The gearbox 63 is arranged inside the second housing 20. A clutch element S2, in this case a friction disk of the clutch device 50, is arranged inside the third housing 30.

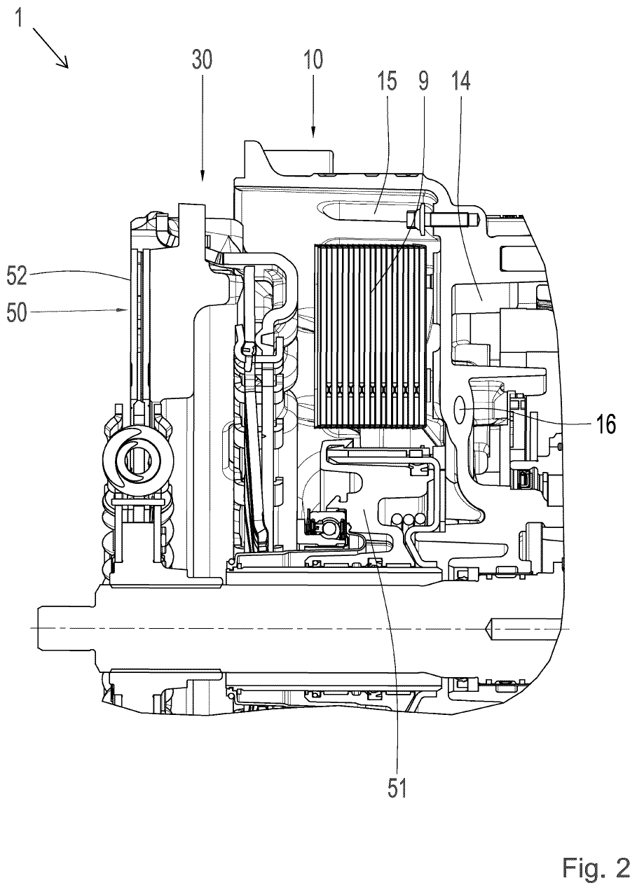

FIG. 2 shows a further sectioned view of the embodiment of the drive unit 1 in FIG. 1. In FIG. 2 the heat exchanger 9, the first housing 10 with the drive space 14 and the clutch space 15, the first liquid duct 16, the third housing 30 and the clutch device 50 with the clutch actuating device 51 and the clutch element 52 are shown enlarged.

FIG. 3 shows a sectioned perspective view of an embodiment of the drive unit 1. The second liquid duct 17 and the third liquid duct 18 open onto an outer circumference of the first housing 10. Each of the liquid ducts 17, 18 has at its end a liquid transfer interface at the outer circumference of the first housing 10, which is designed to let in or let out the liquid of the external cooling circuit. The liquid transfer interfaces are orientated in a plane transverse to the axial direction. Relative to the intermediate wall the liquid transfer interfaces are arranged in the axial direction offset in relation to the third housing 30. The liquid transfer interfaces are arranged parallel to one another.

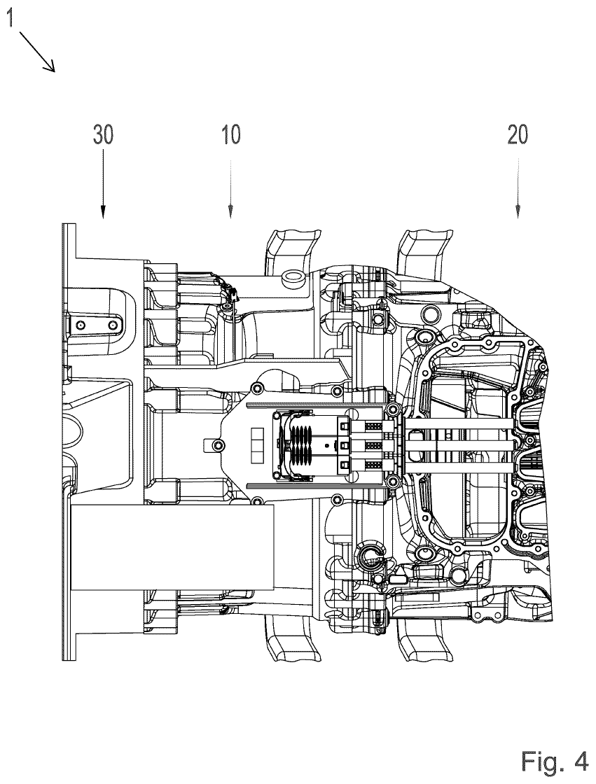

FIG. 4 shows a view from above, of an embodiment of the vehicle with the drive unit 1. FIG. 4 shows the first housing 10, the second housing 20 and the third housing 30 attached to one another by screw connections and fixed to a chassis of the vehicle.

FIG. 1 shows a view from above, of the principle of the vehicle with the drive unit 1. The drive unit 1 is fitted longitudinally in the vehicle and is mechanically functionally connected for driving the vehicle via cardan shafts with two drive elements, in this case two front wheels.

### INDEXES

1 Drive unit
9 Hent exchange
10 Fast housing
14 Drive space
15 Clutch space
16 First liquid duct
17 Second liquid duct
18 Third liquid duct
20 Second housing
30 Third housing
50 Clutch device
51 Clutch actuating device
52 Clutch element
61 First drive machine
62 Transmission gear
63 Gearbox
64 Input element

1. A drive unit (1) for a vehicle, wherein the drive unit (1) comprises.
a gearbox (63) with an input element (64) configured to introduce drive power into the gearbox (63),
a clutch device (50) having a clutch actuating device (51),
a first drive machine (61) configured to drive the vehicle and can be mechanically and functionally connected to the input element (64);
a second drive machine configured to drive the vehicle and can be mechanically and functionally connected to the input element (64) by way of the clutch device (50);
a first housing (10) comprising a clutch space (15) for accommodating the clutch actuating device (51) and comprising a drive space (14) for accommodating the first drive machine (61), wherein relative to the clutch space (15) the drive space (14) is arranged in the axial direction offset to a first side; and
a heat exchanger (9) arranged in a radial direction between an outer circumference of the clutch actuating device (51) and an inner circumference of the first housing (10) inside the clutch space (15).

2. The drive unit (1) according to claim 1, wherein the heat exchanger (9) is configured to convey heat from a liquid in the drive space (14) to a liquid in an external cooling circuit.

3. The drive unit (1) according to claim 1, wherein the heat exchanger (9) is an oil-water beat exchanger

4. The drive unit (1) according to claim 2, wherein the clutch space (15) is separated from the drive space (14) by an intermediate wall, and wherein the intermediate wall bas a number of liquid ducts (16, 17, 18) which are in fluidic connection with the heat exchanger (9).

5. The drive unit (1) according to claim 4, wherein the heat exchanger (9) is attached to the intermediate wall.

6. The drive unit (1) according to claim 1, wherein two liquid ducts (17, 18) open onto an outer circumference of the first housing (10).

7. The drive unit (1) according to claim 1, wherein the first housing (10) is cylindrical.

8. The drive unit (1) according to claim 1, wherein the drive unit (1) comprises a second housing (20) inside which the gearbox (63) is arranged.

9. The drive unit (1) according to claim 8, wherein the drive unit (1) comprises a third housing (30) inside which clutch elements (52) of the clutch device (50) are arranged.

10. A vehicle comprising:
a drive unit (1) according to claim 1; and
at least one drive element designed to drive the vehicle by way of the drive unit (1).
